(19) United States
(12) Patent Application Publication
(10) Pub. No.: US 2026/0312848 A1
(43) Pub. Date: Oct. 8, 2026

(54) WIRELESS COMMUNICATION SYSTEM, WIRELESS STATION, WIRELESS COMMUNICATION METHOD AND WIRELESS COMMUNICATION PROGRAM

(71) Applicant: NTT, Inc., Tokyo (JP)

(72) Inventors: Hiroyuki FURUYA, Musashino-shi, Tokyo (JP); Toshifumi MIYAGI, Musashino-shi, Tokyo (JP)

(73) Assignee: NTT, Inc., Tokyo (JP)

(21) Appl. No.: 19/478,839

(22) PCT Filed: May 25, 2023
(86) PCT No.: PCT/JP2023/019537

§ 371 Date: Oct. 27, 2025

(51) Int. Cl. H04L 27/14

(52) U.S. Cl. CPC H04L 27/14

(57) ABSTRACT

At least one of the first and the second wireless station demodulates the received radio wave. At least one of them adds the reception time of the radio wave in which the demodulation error has occurred to the demodulation error information, and notifies the analyzer of the demodulation error information. An analyzer estimates a communication mode of a jamming wave. The analyzer notifies a counterpart station of a wireless station that has notified the demodulation error information among the first and the second wireless station of the estimation result of the communication mode of the jamming wave and the reception time. The wireless station that has received the estimation result and the reception time controls the radio wave transmitted by itself so as to cancel the jamming wave at the transmission timing defined in the communication mode of the jamming wave on a basis of the reception time.

### FIELD

The present disclosure relates to a wireless communication system, a wireless station, a wireless communication method, and a wireless communication program that detect a jamming wave that jams continuous wireless communication performed by the wireless communication system and control the communication of the wireless communication system according to a communication mode of the jamming wave.

### BACKGROUND

As a countermeasure against a jamming wave of wireless communication, an automatic transmitter power control (ATPC) technology or the like that measures communication quality and controls own transmission power according to C/I is known.

Patent Literature 1 discloses a wireless communication system including a determination circuit that determines, at the time of detection of an interference signal such as a radar signal, whether to continue communication via a wireless LAN or switch to communication via another communication system on the basis of a collected channel communication status. As a result, it is possible to prevent a fatal traffic decrease for the user from occurring when an interference signal such as a radar signal is detected.

### CITATION LIST

### Patent Literature

Patent Literature 1: JP 2015-95838 A

### SUMMARY

### Technical Problem

However, in the above method, it is not possible to estimate the communication mode of the jamming wave and perform adaptive transmission control based on the communication mode.

In order to solve the above-described problems, the first object of the present disclosure is to provide a wireless communication system capable of estimating a communication mode of a jamming wave and performing adaptive transmission control based on the communication mode.

In addition, the second object is to provide a wireless station capable of estimating a communication mode of a jamming wave and performing adaptive transmission control based on the communication mode.

In addition, the third object is to provide a wireless communication method capable of estimating a communication mode of a jamming wave and performing adaptive transmission control based on the communication mode.

In addition, the fourth object is to provide a wireless communication program capable of estimating a communication mode of a jamming wave and performing adaptive transmission control based on the communication mode.

### Solution to Problem

According to a first aspect of the present disclosure, a wireless communication system includes:
a first wireless station;
a second wireless station that performs wireless communication with the first wireless station by continuous radio waves; and
an analysis device, in which
at least one of the first wireless station and the second wireless station is configured to execute:
demodulation processing of demodulating the received radio wave;
processing of setting a temporal change pattern of a magnitude of a demodulation error as demodulation error information; and
notification processing of adding information of reception time of the radio wave in which the demodulation error has occurred to the demodulation error information and notifying the analysis device of the demodulation error information,
the analysis device is configured to execute:
processing of storing a temporal change pattern of a radio signal in wireless packet communication capable of interfering with the wireless communication as a transmission pattern for each communication mode;
processing of comparing the demodulation error information with the transmission pattern;
estimation processing of estimating a communication mode having a transmission pattern having a high matching rate with the demodulation error information as a communication mode of a jamming wave for the wireless communication; and
processing of notifying a counterpart station of a wireless station that has notified the demodulation error information among the first wireless station and the second wireless station of an estimation result of a communication mode of the jamming wave and information of the reception time, and
the wireless station that has received the estimation result and the information of the reception time is configured to execute:
processing of controlling the radio wave transmitted by the wireless station itself so as to cancel the jamming wave at a transmission timing defined in a communication mode of the jamming wave on a basis of the information of the reception time.

According to a second aspect, a wireless station that performs wireless communication by continuous radio waves, the wireless station is configured to execute:
demodulation processing of demodulating the radio wave received from another wireless station;
processing of setting a temporal change pattern of a magnitude of a demodulation error as demodulation error information;
notification processing of adding information of reception time of the radio wave in which the demodulation error has occurred to the demodulation error information and notifying another device of the demodulation error information;
processing of receiving, from the other device, an estimation result of a communication mode of a jamming wave for the wireless communication and information of reception time of the jamming wave in the other wireless station; and
processing of controlling a radio wave transmitted by the wireless station itself so as to cancel the jamming wave at a transmission timing defined in a communication mode of the jamming wave on a basis of the information of the reception time.

According to a third aspect, a wireless communication method, in which
at least one of a first wireless station and a second wireless station that perform wireless communication with each other by continuous radio waves includes:
demodulating the received radio wave;
setting a temporal change pattern of a magnitude of a demodulation error as demodulation error information; and
adding information of reception time of the radio wave in which the demodulation error has occurred to the demodulation error information and notifying an analysis device of the demodulation error information,
the analysis device includes:
storing a temporal change pattern of a radio signal in wireless packet communication capable of interfering with the wireless communication as a transmission pattern for each communication mode;
comparing the demodulation error information with the transmission pattern;
estimating a communication mode having a transmission pattern having a high matching rate with the demodulation error information as a communication mode of a jamming wave for the wireless communication; and
notifying a counterpart station of a wireless station that has notified the demodulation error information among the first wireless station and the second wireless station of an estimation result of a communication mode of the jamming wave and information of the reception time, and
a wireless station that has received the estimation result and the information of the reception time includes:
controlling the radio wave transmitted by the wireless station itself so as to cancel the jamming wave at a transmission timing defined in a communication mode of the jamming wave on a basis of the information of the reception time.

According to a fourth aspect, a wireless communication program to cause a wireless station that performs wireless communication by continuous radio waves to execute, the wireless communication program comprising a program to cause a wireless station to execute:
demodulation processing of demodulating the radio wave received from another wireless station;
processing of setting a temporal change pattern of a magnitude of a demodulation error as demodulation error information;
notification processing of adding information of reception time of the radio wave in which the demodulation error has occurred to the demodulation error information and notifying another device of the demodulation error information;
processing of receiving, from the other device, an estimation result of a communication mode of a jamming wave for the wireless communication and information of reception time of the jamming wave in the other wireless station; and
processing of controlling the radio wave transmitted by the wireless station itself so as to cancel the jamming wave at a transmission timing defined in a communication mode of the jamming wave on a basis of the information of the reception time.

### Advantageous Effects of Invention

According to the first to fourth aspects of the present disclosure, it is possible to provide a wireless communication system, a wireless station, a wireless communication method, and a wireless communication program capable of estimating a communication mode of a jamming wave and performing adaptive transmission control based on the communication mode.

### BRIEF DESCRIPTION OF DRAWINGS

FIG. 1 is a diagram illustrating a configuration example of a wireless communication system according to the first embodiment.

FIG. 2 is a diagram for explaining a transmission mode of a radio wave according to the first embodiment.

FIG. 3 is a diagram for explaining a transmission mode of a jamming wave according to the first embodiment.

FIG. 4 is a diagram for explaining a relationship between a transmission mode of a jamming wave and content data according to the first embodiment.

FIG. 5 is a schematic diagram illustrating a state in which a radio wave is demodulated in a case where there is no interference of a jamming wave according to the first embodiment.

FIG. 6 is a schematic diagram illustrating a state in which a jamming wave and a radio wave including a jamming wave are demodulated according to the first embodiment.

FIG. 7 is a schematic diagram illustrating a state in which a jamming wave and a radio wave including a jamming wave are demodulated according to the first embodiment.

FIG. 8 is a transmission pattern of a radio signal of a communication mode A that can be a jamming wave for fixed wireless communication according to the first embodiment.

FIG. 9 is a transmission pattern of a radio signal of a communication mode B that can be a jamming wave for fixed wireless communication according to the first embodiment.

FIG. 10 is a transmission pattern of a radio signal of a communication mode C that can be a jamming wave for fixed wireless communication according to the first embodiment.

FIG. 11 is a schematic diagram illustrating demodulation error information of a radio wave according to the first embodiment.

FIG. 12 is a schematic diagram illustrating a relationship between a magnitude of a demodulation error and content data according to the first embodiment.

FIG. 13 is a diagram for explaining transmission control performed by the second wireless station according to the first embodiment.

FIG. 14 is a block diagram illustrating a configuration of the wireless communication system according to the first embodiment.

FIG. 15 is a block diagram illustrating a configuration of an analysis device according to the first embodiment.

### DESCRIPTION OF EMBODIMENTS

A wireless communication system, a wireless station, a wireless communication method, and a wireless communication program according to an embodiment of the present disclosure will be described with reference to the drawings. The same or corresponding components are denoted by the same reference signs, and repetition of the description may be omitted.

### First Embodiment

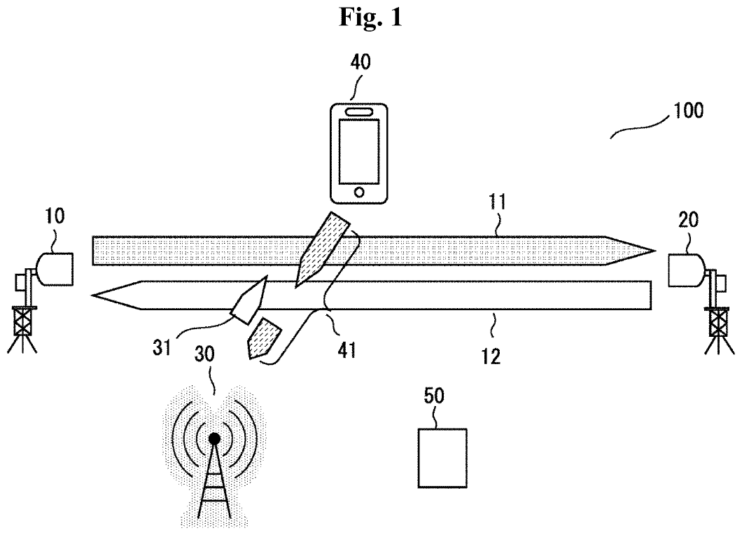

FIG. 1 is a diagram illustrating a configuration example of a wireless communication system 100 according to the first embodiment. The wireless communication system 100 includes the first wireless station 10 and the second wireless station 20.

The first wireless station 10 is fixedly used, converts a signal to be transmitted into a radio wave 11, and transmits the radio wave to the second wireless station 20. In addition, the first wireless station 10 receives a radio wave 12 transmitted from the second wireless station 20. The first wireless station 10 is a base station installed on a utility pole, a rooftop of a building, or the like, a relay station equipped with a parabolic antenna installed on a mountain, or the like.

The second wireless station 20 is fixedly used, and performs wireless communication with the first wireless station 10. The second wireless station 20 is a subscriber station installed in a house or the like, the above-described relay station, or the like.

Hereinafter, wireless communication performed by the first wireless station 10 and the second wireless station 20 is referred to as fixed wireless communication. Note that, the fixed wireless communication is not limited to communication using a known fixed wireless access link. In the present disclosure, wireless communication using continuous radio waves between fixedly used wireless stations is collectively referred to as fixed wireless communication.

The first jamming wireless station 30 establishes a mobile wireless link with the second jamming wireless station 40. The wireless communication performed here is wireless packet communication such as wireless local area network (LAN) communication. The first jamming wireless station 30 is, for example, a base station of the wireless LAN. The second jamming wireless station 40 is, for example, a mobile terminal such as a smartphone.

The radio waves transmitted and received between the first jamming wireless station 30 and the second jamming wireless station 40 interfere with the fixed wireless communication described above. Therefore, hereinafter, the radio wave transmitted by the first jamming wireless station 30 is referred to as a jamming wave 31, and the radio wave transmitted by the second jamming wireless station 40 is referred to as a jamming wave 41.

In a case where the jamming wave 31 or the jamming wave 41 is detected in the demodulation of the radio wave 12, the first wireless station 10 notifies an analysis device 50 of demodulation error information 5. The same applies to the second wireless station 20.

The analysis device 50 estimates the communication mode of the jamming wave on the basis of the demodulation error information 5 notified from the first wireless station 10. Note that, the communication mode here refers to a wireless standard defined by IEEE802.11, a communication protocol, a wireless standard defined for each piece of transmission content data, or the like. Furthermore, the analysis device 50 notifies the second wireless station 20, which is a communication partner of the first wireless station 10, of the estimation result of the communication mode. The second wireless station 20 performs transmission control at a transmission timing defined by the communication mode. The same applies to the description even if the first wireless station 10 is replaced with the second wireless station 20 and the second wireless station 20 is replaced with the first wireless station 10.

Hereinafter, a wireless communication system 100 of the present disclosure will be continuously described. However, in order to simplify the description, in a case where it is not necessary to distinguish the radio wave 11 and the radio wave 12, they are referred to as a radio wave 1. In addition, in a case where it is not necessary to distinguish the first wireless station 10 and the second wireless station 20, they are referred to as a wireless station 2. Furthermore, in a case where it is not necessary to distinguish the jamming wave 31 and the jamming wave 41, they are referred to as a jamming wave 3. In addition, in a case where it is not necessary to distinguish the first jamming wireless station 30 and the second jamming wireless station 40, they are referred to as a jamming wireless station 4.

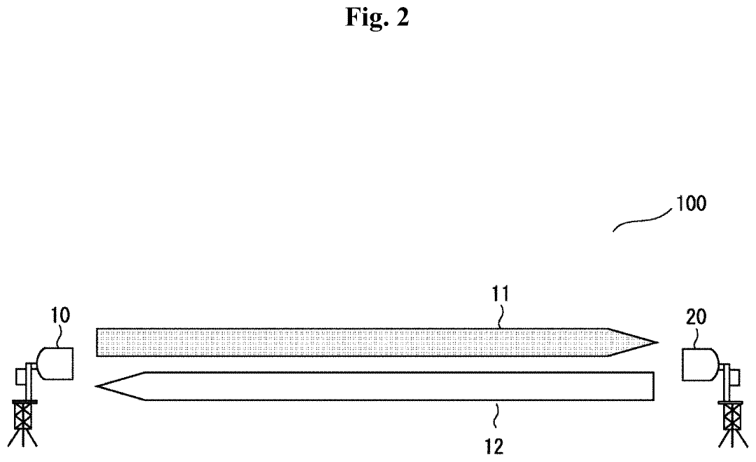

FIG. 2 is a diagram for explaining a transmission mode of the radio wave 1 according to the first embodiment. The radio wave 1 in the fixed wireless communication is continuously transmitted regardless of the presence or absence of transmission data.

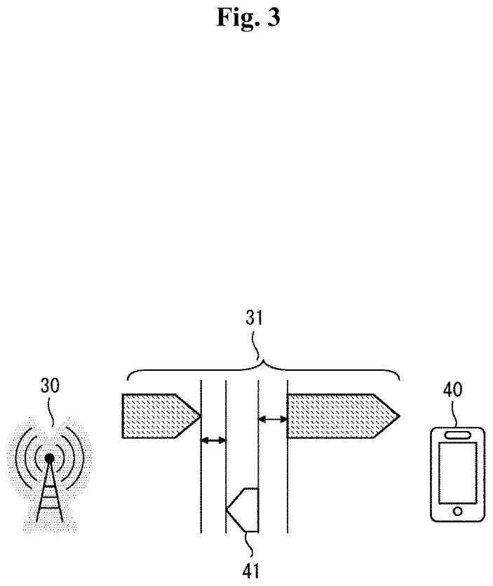

FIG. 3 is a diagram for explaining a transmission mode of the jamming wave 3 according to the first embodiment. Unlike the radio wave 1, the jamming wave 3 is transmitted in an intermittent pattern specific to the communication mode. This is because the packet interval, the communication standby time, and the like according to the communication mode are set in the wireless packet communication. For example, in the wireless LAN, a radio signal called a beacon having a cycle of about 100 ms is transmitted from the base station. In addition, in carrier sense multiple access with collision avoidance (CSMA/CA) algorithm, there is the transmission standby time specific to the algorithm represented by short inter frame space (SIFS) and distributed coordination function inter frame space (DIFS).

In addition, in a case where the jamming wave 3 includes content data such as voice or a moving image, the jamming wave 3 is transmitted in a pattern defined for each content data.

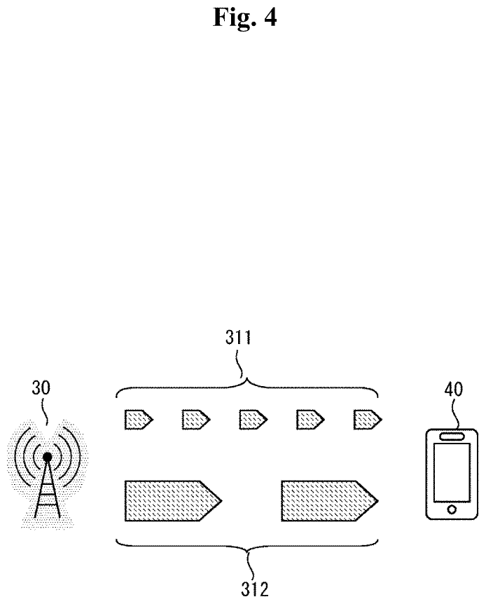

FIG. 4 is a diagram for explaining a relationship between a transmission mode of the jamming wave 3 and content data according to the first embodiment. For example, in the case of voice data 311, a short-time radio signal is repeatedly transmitted with a small output. For example, in the case of VoIP, radio signals are transmitted at intervals of about 20 ms or 40 ms according to the voice codec in the G.711 standard. On the other hand, in the case of moving image data 312, a long-time radio signal is repeatedly transmitted with a large output.

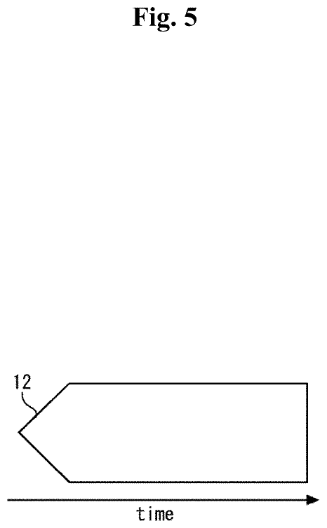

FIG. 5 is a schematic diagram illustrating a state in which the radio wave 12 is demodulated when there is no interference of the jamming wave 3 according to the first embodiment. As the radio wave 12 reaches the first wireless station 10, demodulation is started, and a demodulated signal having a strength corresponding to a radio output of the radio wave 12 is generated. The demodulated signal continues to be generated as long as the radio wave 12 continues to be transmitted and generated. In a case where there is no interference of the jamming wave 3, a normal demodulated signal that changes with time in such a pattern is obtained.

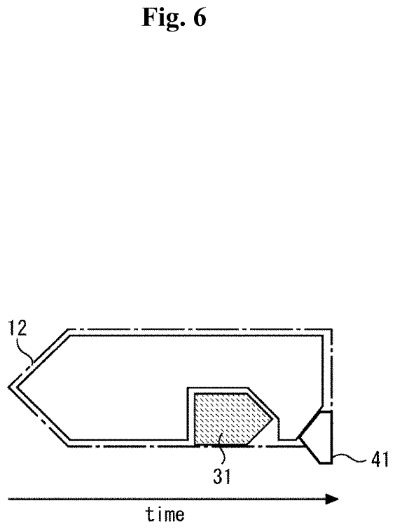

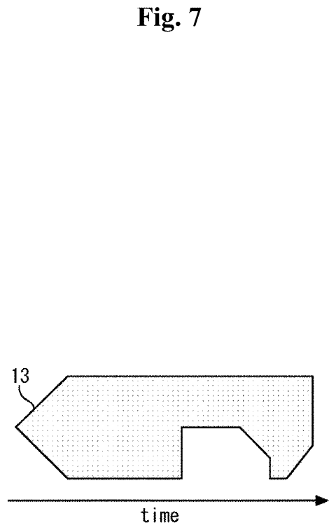

FIGS. 6 and 7 are schematic diagrams illustrating a state in which the radio wave 12 including the jamming wave 31 and the jamming wave 41 is demodulated according to the first embodiment. The radio wave 12 is demodulated in the similar manner to in FIG. 5, but is not normally demodulated in a time region including interference between the jamming wave 31 and the jamming wave 41 as illustrated in FIG. 6. As a result, an abnormal demodulated signal 13 that changes with time in a pattern as illustrated in FIG. 7 is obtained.

Note that, the description of FIGS. 5 to 7 also applies to a case where the second wireless station 20 demodulates the radio wave 11.

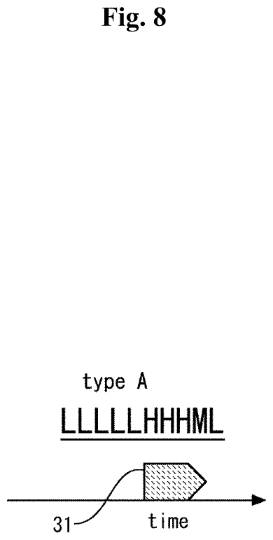

FIG. 8 illustrates a transmission pattern of a radio signal of the communication mode A that can be the jamming wave 31 for fixed wireless communication according to the first embodiment. The vertical axis represents radio signal output indicated by three values of H (high), M (middle), and L (low). The horizontal axis represents elapsed time. The signal output is Low until the transmission is started. When a radio signal starts to be transmitted, the signal output becomes High. Furthermore, immediately before the transmission of the radio signal is completed, the signal output becomes Middle, and returns to Low as the transmission of the radio signal is completed. As a result, the transmission pattern of the communication mode A changes into LLLLLHHHML.

As described above, the jamming wave 31 is transmitted in an intermittent pattern specific to the communication mode. In the example of FIG. 8, the characteristics of the communication mode A appear in a period in which the signal output becomes High.

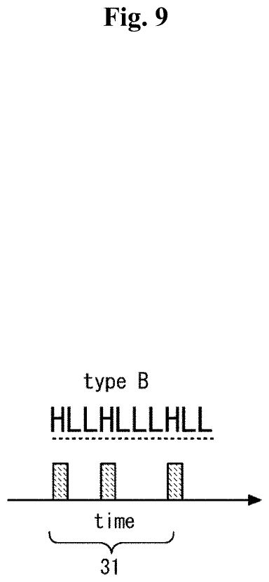

FIG. 9 illustrates a transmission pattern of a radio signal of the communication mode B that can be the jamming wave 31 for fixed wireless communication according to the first embodiment. The vertical axis and the horizontal axis are similar to those in FIG. 8. The transmission pattern of the communication mode B changes into HLLHLLLHLL. Here, the characteristics of the communication mode B appear in the interval time until the signal output becomes High.

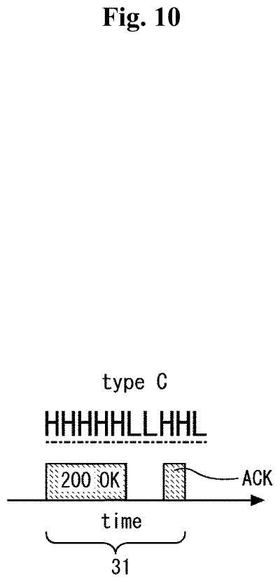

FIG. 10 illustrates a transmission pattern of a radio signal of the communication mode C that can be the jamming wave 31 for fixed wireless communication according to the first embodiment. The vertical axis and the horizontal axis are similar to those in FIG. 8. Here, it is assumed that the communication mode C is a handshake of voice over internet protocol (VOIP). 200OK and ACK are response signals exchanged between the transmission side and the reception side in VoIP. The signal output of the radio signal also changes with time on the basis of the temporal change pattern of these response signals. The transmission pattern of the communication mode C is HHHHLLHHL.

The analysis device 50 stores, as the template 151, the transmission pattern for each wireless standard as illustrated in FIGS. 8 to 9 and the transmission pattern for each transmission content data as illustrated in FIG. 10. This makes it possible to compare the demodulation error information notified from the wireless station 2 with the transmission pattern recorded in the template to estimate the communication mode of the jamming wave 3.

In FIGS. 8 to 10, the vertical axis represents three values, but the value of the vertical axis may be continuous. In addition, the description of FIGS. 8 to 10 also applies to the jamming wave 41.

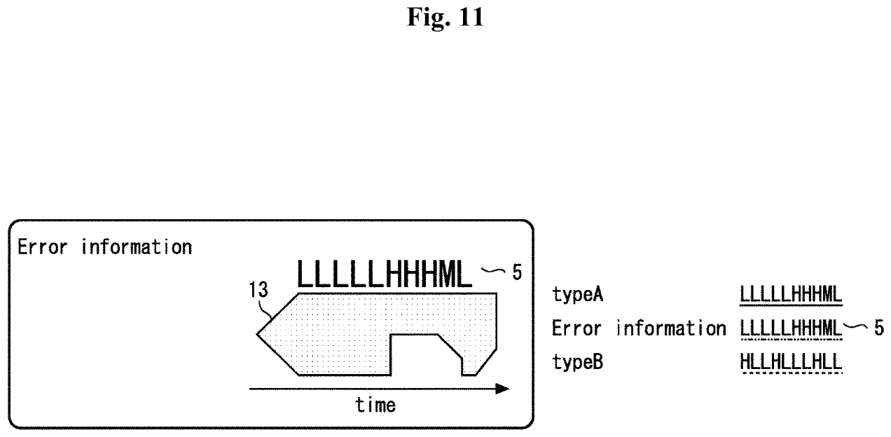

FIG. 11 is a schematic diagram illustrating the demodulation error information 5 of the radio wave 1 according to the first embodiment. The vertical axis indicates the magnitude of the demodulation error indicated by three values of H (high), M (middle), and L (low). The horizontal axis represents elapsed time. The magnitude of the demodulation error changes with time according to the transmission pattern of the jamming wave 3. In the example of FIG. 11, the magnitude of the demodulation error is changed into LLLLLHHHML. The wireless station 2 notifies the analysis device 50 of such a temporal change pattern of the demodulation error as the demodulation error information 5.

The analysis device 50 compares the notified demodulation error information 5 with the transmission pattern recorded in the template 151. In the example of FIG. 11, the demodulation error information 5 changing into LLLLLHHHML is compared with the transmission patterns of the communication mode A and the communication mode B. Since the demodulation error information 5 has a high matching rate with the transmission pattern of the communication mode A, it can be estimated that the communication mode of the jamming wave 3 is the communication mode A. For the estimation, machine learning or mathematical analysis may also be used.

Note that, the communication mode that can be estimated by the analysis device 50 is not limited to the above examples, and can be estimated by other communication modes such as a new radio-unlicensed (NR-U) system and a time division duplex (TDD) system in a 5G mobile communication system.

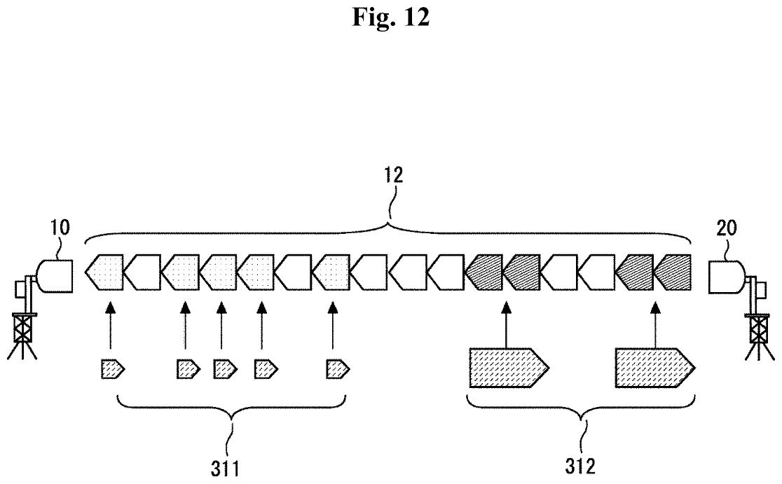

FIG. 12 is a schematic diagram illustrating a relationship between a magnitude of a demodulation error and content data according to the first embodiment. In order to simplify the description, here, the radio wave 12 is represented in a state in which a plurality of arrows is connected. Since the magnitude of the demodulation error depends on the signal output of the jamming wave 3, the ratio (hereinafter, referred to as an error rate) of High as the magnitude of the demodulation error in the demodulation error information 5 increases as the signal output of the jamming wave 3 increases. This means that the error rate depends on the type of content data included in the jamming wave 3. Therefore, while the radio wave 12 is interfered with the jamming wave 3, the demodulation error information 5 having an error rate corresponding to the content data included in the jamming wave 3 is continuously generated.

While the jamming wave 3 including the voice data 311 is transmitted, the demodulation error information 5 with a low error rate continues to be generated. On the other hand, while the jamming wave 3 including the moving image data 312 is transmitted, the demodulation error information 5 having a high error rate is continuously generated. In the drawing, the color density of an arrow indicating the radio wave 12 indicates the magnitude of the error rate at the time of demodulating the radio wave. A darker color indicates a higher error rate.

The analysis device 50 compares the demodulation error information 5 with the transmission pattern recorded in the template 151 to estimate the communication mode of the jamming wave 3 and the content data included in the jamming wave 3.

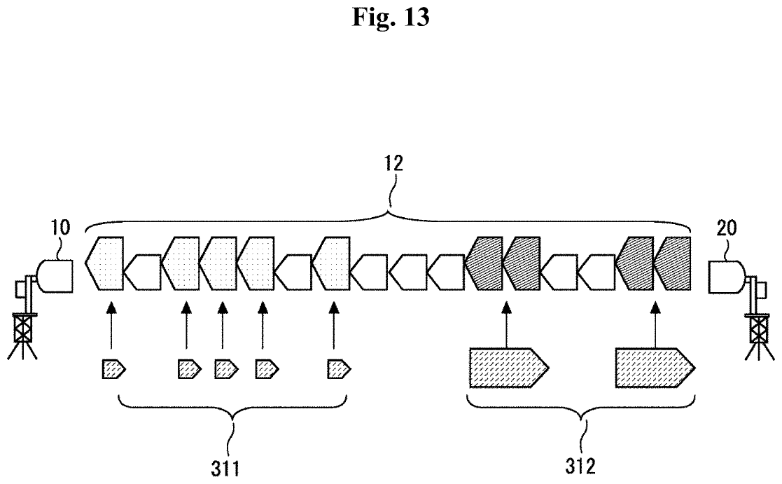

FIG. 13 is a diagram for explaining transmission control performed by the second wireless station 20 according to the first embodiment. The second wireless station 20 controls the transmission of the radio wave 12 at the transmission timing defined in the communication mode of the jamming wave 3. Here, the transmission control includes at least one of change of a modulation mode and an error correction mode and control of a transmission output.

In the example of FIG. 13, the second wireless station 20 increases the transmission output of the radio wave 12 at the transmission timing defined in the communication standard of the voice data 311 and the moving image data 312 included in the jamming wave 3. As a result, it is possible to prevent the first wireless station 10 on the reception side from being affected by the jamming wave 3. As a result, it is possible to improve resistance of the fixed wireless communication.

The amount of increase in the transmission output in the transmission control may be determined in consideration of the communication mode of the jamming wave 3. As described above, the output of the radio signal including the voice data 311 is smaller than that of the moving image data 312. Therefore, the amount of increase in the transmission output for the jamming wave 3 including the voice data 311 can be set to be smaller than the amount of increase in the transmission output for the jamming wave 3 including the moving image data 312. As a result, it is possible to prevent the controlled communication quality from becoming excessive.

Here, the transmission control in the second wireless station 20 can be performed without stopping the fixed wireless communication. This is common not only in the transmission output control but also in the change of the modulation mode and the error correction mode or the like. In so far as the transmission output control, the transmission output control can be performed without sacrificing communication quality such as throughput and delay. Note that, the description of FIG. 13 also applies to the first wireless station 10.

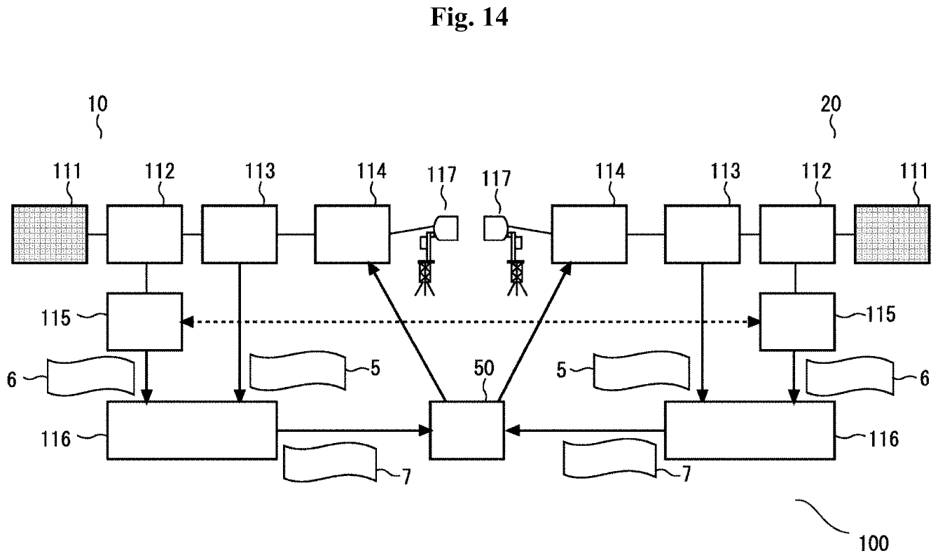

FIG. 14 is a block diagram illustrating a configuration of the wireless communication system 100 according to the first embodiment. In the first wireless station 10, an antenna 117 transmits and receives the radio wave 12. A transmission/reception unit 114 is a unit that amplifies, shapes, and the like a high-frequency radio signal. In addition, the transmission/reception unit 114 receives, from the analysis device 50, the estimation result of the communication mode of the jamming wave 3 detected by the first wireless station 10 and reception time information 6 of the jamming wave 3 in the second wireless station 20. Furthermore, the transmission/reception unit 114 performs transmission control of the radio wave 11 at a transmission timing defined in the communication mode. In the transmission of the radio wave 11, the transmission of the radio wave 11 is started at the timing of canceling the jamming wave 3 on the basis of the reception time information 6. A modulation/demodulation unit 113 is a unit that performs analog modulation/demodulation. When a demodulation error occurs, the modulation/demodulation unit 113 notifies a storage unit 116 of the demodulation error information 5.

An IF unit 112 converts the radio wave 12 having a high frequency into an intermediate frequency (IF) band. A transmission device 111 is an interface that receives a signal from another device.

A time synchronization unit 115 performs time synchronization using a global positioning system (GPS) or the like with the time synchronization unit 115 of the second wireless station 20. Furthermore, the reception time information 6 of the radio wave 12 causing the demodulation error is notified to the storage unit 116. By performing time synchronization, the accuracy of the reception time of the jamming wave 3 in each of the two wireless stations can be enhanced. The storage unit 116 adds the reception time information 6 notified from the time synchronization unit 115 to the demodulation error information 5 notified from the modulation/demodulation unit 113, and then stores the demodulation error information 5. Hereinafter, the demodulation error information 5 to which the reception time information 6 has been added is referred to as time-added demodulation error information 7. The storage unit 116 notifies the analysis device 50 of the time-added demodulation error information 7.

The storage unit 116 is a storage device such as a hard disk drive or a solid state drive (SSD). These storage devices may not necessarily be built in the first wireless station 10, and may be connected online.

Note that, the above description is also common to the second wireless station 20, and thus description thereof is omitted.

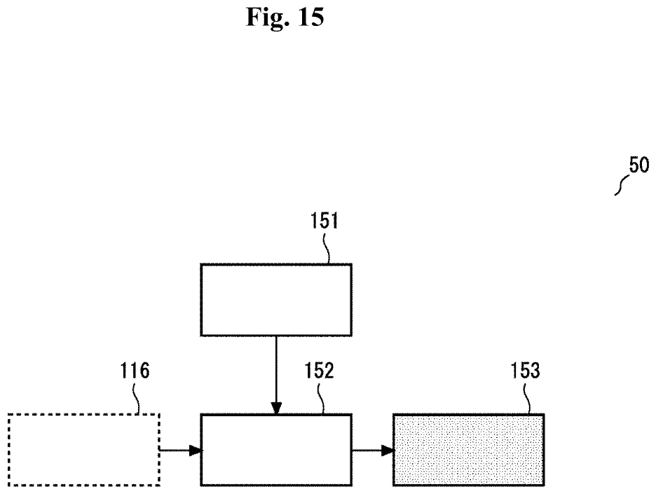

FIG. 15 is a block diagram illustrating a configuration of the analysis device 50 according to the first embodiment. A communication mode estimation unit 152 receives the time-added demodulation error information 7 from the storage unit 116 of the first wireless station 10. Furthermore, the communication mode estimation unit 152 compares the transmission pattern recorded in the template 151 with the demodulation error information 5 included in the time-added demodulation error information 7 to estimate the communication mode of the jamming wave 3. Furthermore, the estimation result and the reception time information 6 are notified to the second wireless station 20. The first storage unit 153 stores information of the estimation result of the communication mode of the jamming wave 3.

In addition, the analysis device 50 also estimates the communication mode for the jamming wave 3 detected by the second wireless station 20 by a similar method. Furthermore, the estimation result of the communication mode of the jamming wave 3 and the reception time information 6 of the jamming wave 3 in the second wireless station 20 are notified to the first wireless station 10.

As described above, in the present disclosure, it is possible to provide the wireless communication system 100 capable of estimating a communication mode of a jamming wave and performing adaptive transmission control based on the communication mode.

### First Modification

Note that, the processing performed by the wireless station 2 and the analysis device 50 may be executed by a program using a computer including a CPU and a memory and storing the program in the memory. Alternatively, the processing may be executed by the program using an integrated circuit such as a field programmable gate array (FPGA). Note that, the program may be provided by being recorded in a storage medium, or may be provided through a network. This point is also common to all the following embodiments.

### Second Modification

Note that, the analysis device 50 may be incorporated in either the first wireless station 10 or the second wireless station 20. As a result, the wireless station 2 and the analysis device 50 can communicate with each other using a control link provided in the wireless station 2.

### Third Modification

Note that, the present disclosure is not limited to the above-described embodiments, and various modifications can be made in the implementation stage without departing from the gist of the present disclosure. In addition, the embodiments may be implemented in appropriate combination, and in that case, a combined effect can be obtained.

### Fourth Modification

If there are the demodulation error information 5 and the reception time information 6 in one of the first wireless station 10 and the second wireless station 20, the analysis device 50 can estimate the communication mode of the jamming wave 3.

Only one wireless station 2 may be configured to notify the storage unit 116 of the demodulation error information 5. In this case, it means that only the counterpart station of the wireless station 2 that has notified the demodulation error information 5 performs the transmission control, and the above-described effect can be obtained in the fixed wireless communication in at least one direction.

### REFERENCE SIGNS LIST

1 Radio wave
2 Wireless station
3 Jamming wave
4 Jamming wireless station
5 Demodulation error information
6 Reception time information
7 Time-added demodulation error information
10 First wireless station
11 Radio wave
12 Radio wave
13 Abnormal demodulated signal
14 Normal demodulated signal
20 Second wireless station
30 First jamming wireless station
31 Jamming wave
40 Second jamming wireless station
41 Jamming wave
50 Analysis device
100 Wireless communication system
111 Transmission device
112 IF unit
113 Modulation/demodulation unit
114 Transmission/reception unit
115 Time synchronization unit
116 Storage unit
117 Antenna
151 Template
152 Communication mode estimation unit
153 First storage unit
311 Voice data
312 Moving image data

1. A wireless communication system comprising:
a first wireless station;
a second wireless station configured to perform wireless communication with the first wireless station by continuous radio waves; and
an analyzer, wherein
at least one of the first wireless station and the second wireless station is configured to execute:
demodulating the received radio wave;
setting a temporal change pattern of a magnitude of a demodulation error as demodulation error information; and
adding information of reception time of the radio wave in which the demodulation error has occurred to the demodulation error information and notifying the analyzer of the demodulation error information,
the analyzer is configured to execute:
storing a temporal change pattern of a radio signal in wireless packet communication capable of interfering with the wireless communication as a transmission pattern for each communication mode;
comparing the demodulation error information with the transmission pattern;
estimating a communication mode having a transmission pattern having a high matching rate with the demodulation error information as a communication mode of a jamming wave for the wireless communication; and
notifying a counterpart station of a wireless station that has notified the demodulation error information among the first wireless station and the second wireless station of an estimation result of a communication mode of the jamming wave and information of the reception time, and
the wireless station that has received the estimation result and the information of the reception time is configured to execute:
controlling the radio wave transmitted by the wireless station itself to cancel the jamming wave at a transmission timing defined in a communication mode of the jamming wave on a basis of the information of the reception time.

2. The wireless communication system according to claim 1, wherein the controlling includes at least one of transmission output control, modulation mode control, and error correction mode control.

3. The wireless communication system according to claim 2, wherein in the transmission output control, a transmission output of the radio wave is controlled according to a signal output defined in a communication mode of the jamming wave.

4. The wireless communication system according to claim 1, wherein the first wireless station and the second wireless station further execute synchronizing time with each other, and
the information of the reception time is time-synchronized between the first wireless station and the second wireless station.

5. A wireless station configured to perform wireless communication by continuous radio waves, the wireless station configured to execute:
demodulating the radio wave received from another wireless station;
setting a temporal change pattern of a magnitude of a demodulation error as demodulation error information;
adding information of reception time of the radio wave in which the demodulation error has occurred to the demodulation error information and notifying another device of the demodulation error information;
receiving, from the other device, an estimation result of a communication mode of a jamming wave for the wireless communication and information of reception time of the jamming wave in the other wireless station; and
controlling a radio wave transmitted by the wireless station itself so as to cancel the jamming wave at a transmission timing defined in a communication mode of the jamming wave on a basis of the information of the reception time.

6. The wireless station according to claim 5, wherein the controlling includes at least one of transmission output control, modulation mode control, and error correction mode control.

7. A wireless communication method comprising:
causing at least one of a first wireless station and a second wireless station configured to perform wireless communication with each other by continuous radio waves to:
demodulate the received radio wave;
set a temporal change pattern of a magnitude of a demodulation error as demodulation error information; and
add information of reception time of the radio wave in which the demodulation error has occurred to the demodulation error information and notifying an analyzer of the demodulation error information,
causing the analyzer to:
store a temporal change pattern of a radio signal in wireless packet communication capable of interfering with the wireless communication as a transmission pattern for each communication mode;
compare the demodulation error information with the transmission pattern;
estimate a communication mode having a transmission pattern having a high matching rate with the demodulation error information as a communication mode of a jamming wave for the wireless communication; and
notify a counterpart station of a wireless station that has notified the demodulation error information among the first wireless station and the second wireless station of an estimation result of a communication mode of the jamming wave and information of the reception time, and
causing a wireless station that has received the estimation result and the information of the reception time to:
control the radio wave transmitted by the wireless station itself so as to cancel the jamming wave at a transmission timing defined in a communication mode of the jamming wave on a basis of the information of the reception time.

8. A storage medium storing a computer readable wireless communication program which is executed by a computer, the computer readable wireless communication program being configured to cause the computer to function as the wireless station according to claim 5.

9. The wireless communication system according to claim 2, wherein the first wireless station and the second wireless station further execute synchronizing time with each other, and
the information of the reception time is time synchronized between the first wireless station and the second wireless station.

10. The wireless communication system according to claim 3, wherein the first wireless station and the second wireless station further execute synchronizing time with each other, and
the information of the reception time is time synchronized between the first wireless station and the second wireless station.
